(19) United States
(12) Patent Application Publication
(10) Pub. No.: US 2011/0108696 A1
(43) Pub. Date: May 12, 2011

(54) SUPPORT FOR PORTABLE ELECTRONIC DEVICE

(75) Inventor: ZHEN-XING YE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/650,563

(22) Filed: Dec. 31, 2009

(30) Foreign Application Priority Data
Nov. 12, 2009 (CN) 200910309638.2

(51) Int. Cl. F16M 11/38

(52) U.S. Cl. 248/371

(57) ABSTRACT

A support adapted for holding a portable electronic device includes a supporting member, a holding member pivotally connected to the supporting member and holding the portable electronic device, the holding member has an engaging portion extending from a distal end thereof, and a locking member pivotally connected to the supporting member. When the support is in a collapsed state, the holding member, the supporting member and the locking member are reduced to a small rectangular box with the portable electronic device received therein; when the support is deployed, the holding member and the locking member are both rotated up relative to the supporting member, and the engaging portion of the holding member securely engages in a corresponding slot in the locking member, such that the supporting member, the holding member and the locking member cooperatively define a triangular structure supporting the portable electronic device at an angle.

### BACKGROUND

1. Technical Field

The present disclosure generally relates to media playback devices, and more particularly to a support for a portable electronic device.

2. Description of Related Art

Many portable electronic devices provide media playback capability. Such portable electronic devices may include mobile phones, personal digital assistants (PDAs) and portable media players (PMPs). Often, during video playback, hand-holding the portable electronic device can be tiring and inconvenient, as well as hindering the views for multiple viewers. Furthermore, viewing experience is affected if the hand holding the device moves.

For the foregoing reasons, there is a need in the art for a support for a portable electronic device which can overcome the described limitations.

### BRIEF DESCRIPTION OF THE DRAWINGS

FIG. 1 is an isometric view of a support according to an embodiment of the present disclosure, showing the support deployed with a portable electronic device supported thereon.

FIG. 2 is an isometric, exploded view of FIG. 1.

FIG. 3 is similar to FIG. 1, showing the support collapsed.

FIG. 4 is a cross-section view taken along line IV-IV of FIG. 3.

### DETAILED DESCRIPTION

Reference will now be made to the drawing figures to describe the present support in detail.

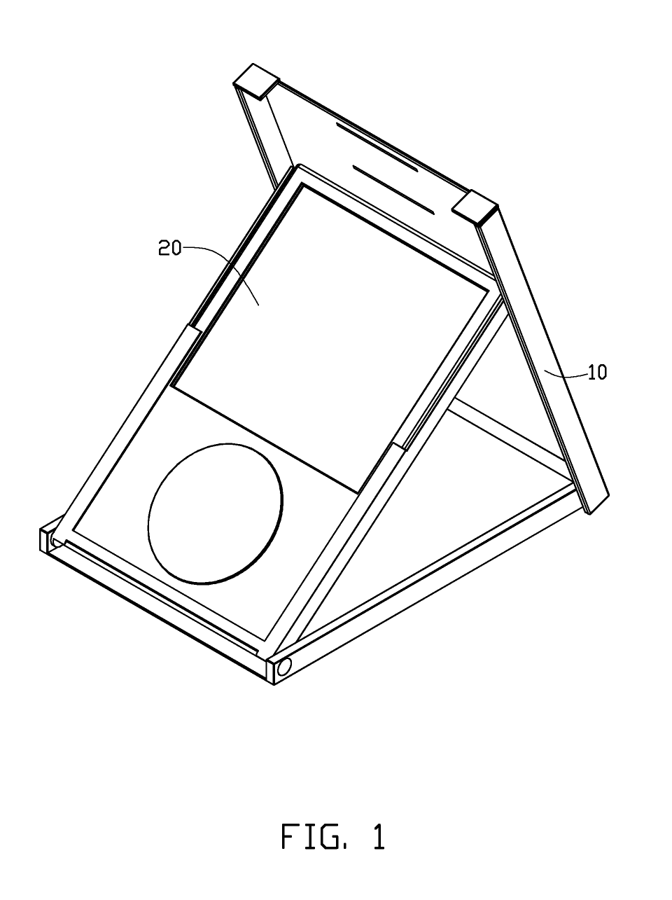

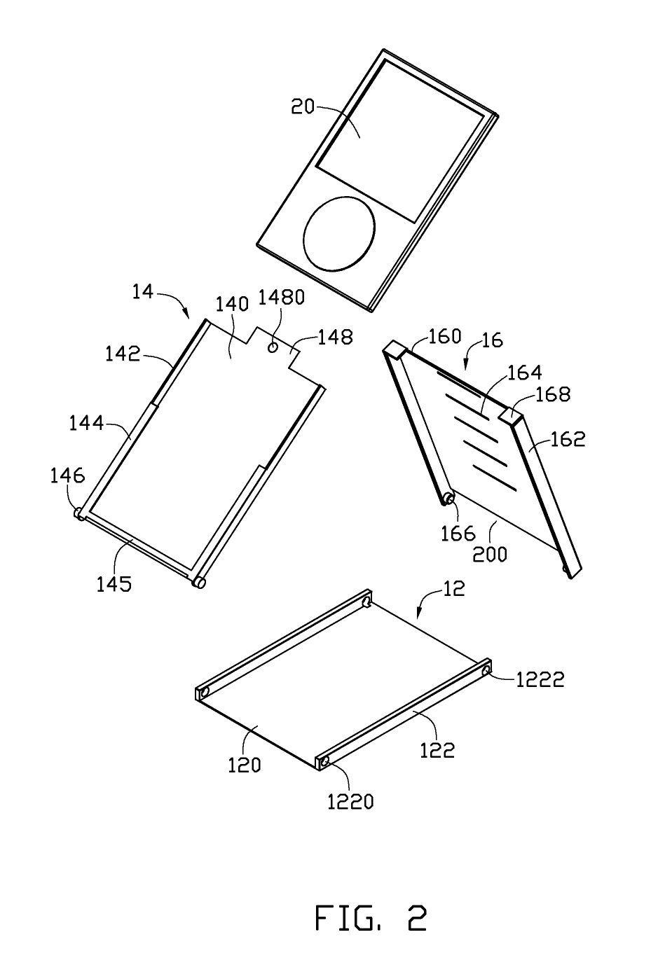

FIGS. 1 and 2 show a support 10 according to an embodiment of the present disclosure. The support 10 can support a portable electronic device 20, providing convenient and comfortable viewing. The portable electronic device 20 may be a mobile phone, a personal digital assistant (PDA), or a portable media player (PMP). The portable electronic device 20 has a screen displaying graphical content including video, text, and images stored therein. The support 10 comprises a supporting member 12, a holding member 14, and a locking member 16 engaging the holding member 14.

The supporting member 12 is flat, and comprises a rectangular first plate 120 and a pair of first arms 122 extending upwardly from left and right lateral sides of the first plate 120. Each of the first arms 122 defines a first pivot hole 1220 and a second pivot hole 1222 at two distal ends thereof respectively.

The holding member 14 is flat, and comprises a rectangular second plate 140 and a pair of second arms 142 extending upwardly from left and right lateral sides, of the second plate 140. The holding member 14 further comprises two contact plates 144 extending horizontally from top portions of the two second arms 142, respectively, and a connecting plate 145 coplanar with and interconnecting the two second arms 142. The two contact plates 142 extend toward each other. The portable electronic device 20 is supported on the second plate 140, contacted by the contact plates 144 and sandwiched between the two second arms 142. Thus, the portable device 20 is securely seated in the holding member 14. The holding member 14 further comprises two first pivot rods 146 pivotally received in the two first pivot holes 1220 respectively. The holding member 14 is rotatable relative to the supporting member 12 around the first pivot rods 146. Each first pivot rod 146 extends outwardly from an outer face of a corresponding second arm 142 at a distal end, that is a rear end, of the second arm 142. The holding member 14 further comprises a rectangular tab 148 protruding outwardly from a center of a lateral side, that is a front lateral side, of the second plate 140. The tab 148 is coplanar with the second plate 140. A through hole 1480 is defined at a center of the tab 148.

The locking member 16 is flat, and comprises a rectangular third plate 160 and a pair of third arms 162 extending downward from two opposite lateral sides, that is left and right lateral sides, of the third plate 160. A plurality of elongated slots 164 is defined in the third plate 160. The slots 164 are parallel to and spaced from each other. The slots 164 are parallel to front and rear lateral sides of the third plate 160. The locking member 16 further comprises two second pivot rods 166 pivotally received in the two second pivot holes 1222, respectively. The locking member 16 is rotatable relative to the supporting member 12 around the second pivot rods 166. The two second pivot rods 166 extend inwardly from inner faces of the third arms 162 at distal ends, that is front ends, of the third arms 162 respectively. The locking member 16 further comprises two baffle walls 168 extending toward each other from distal ends, that is rear ends, of the two third arms 162 respectively. The third plate 160 together with the two third arms 162 defines a rectangular opening 200 at a lateral side, that is a front lateral side, thereof. First plate 120 of the supporting member 12 is narrower than third plate 160 of the locking member 16 and can thus be received in the locking member 16, and wider than the second plate 140 of the holding member 14 so that the holding member 14 could be received in the supporting member 12.

Referring to FIG. 1 again, during deployment of the support 10, the tab 148 of the holding member 14 is received in a corresponding slot 164 of the locking member 16, such that the supporting member 12, the holding member 14 and the locking member 16 cooperatively define a triangular structure supporting the portable electronic device 20.

In order to maximize viewing experience, the angle of the portable electronic device 20 can be changed by the tab 148 being received in different slots 164. For example, as shown in FIG. 1, the tab 148 is received in a middle slot 164, with a resulting angle of the portable electronic device 20 about 30°. The tab 148 can further be received in other slots 164 to provide a variety of viewing angles.

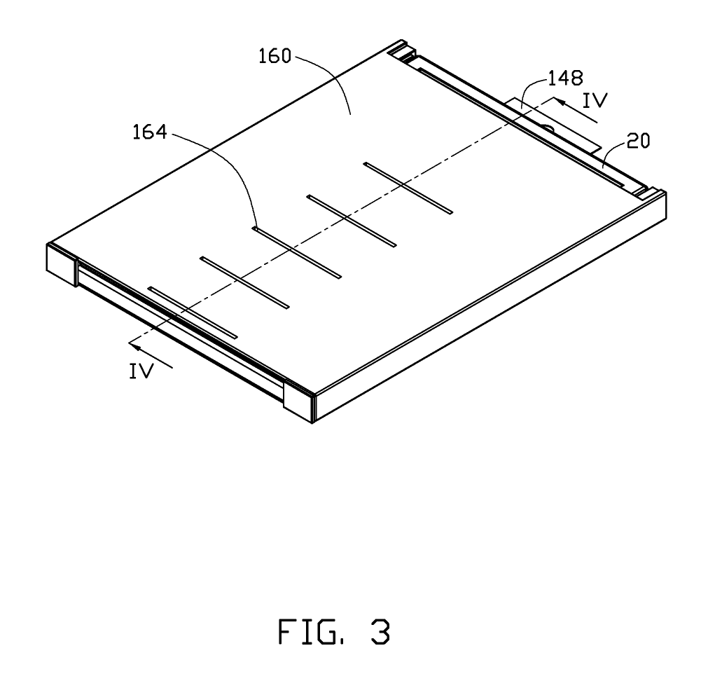

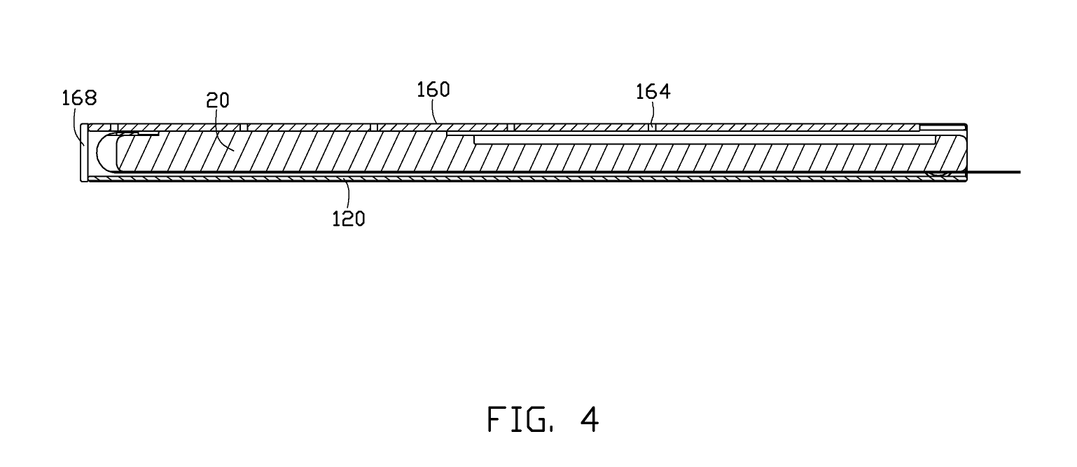

Referring to FIGS. 3 and 4, to collapse the support 10, the locking member 16 is rotated away from the holding member 14 until the tab 148 substantially separates from the corresponding slot 164; the holding member 14 is rotated downward toward the supporting member 12 around the first pivot rods 146 until the second plate 140 of the holding member 14 abuts the first plate 120 of the supporting member 12, and the locking member 16 is rotated downward toward the holding member 14 and the supporting member 12 around the second pivot rods 166 until the locking member 16 is received on the holding member 14. In the collapsed state, the holding member 14 is sandwiched between the two first arms 122 of the supporting member 12, and the supporting member arms 162 of the locking member 16. Since the portable electronic device 20 is entirely received in the holding member 14 and the support 10 is substantially reduced to a small rectangular box, the support 10 can be taken or transported conveniently. A through hole 1480 of the tab 148 of the holding member 14, which extends through the opening 200 of the locking member 16 and is exposed at a front side of the support 10 can support attachment of a lanyard, strap, or other transport aid.

It is to be understood, however, that even though numerous characteristics and advantages of embodiment have been set forth in the foregoing description, together with details of the structures and functions of the embodiment, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A support for supporting a portable electronic device, comprising:
a supporting member;
a holding member pivotally connected to the supporting member for supporting the portable electronic device thereon, the holding member comprising an engaging portion at a distal end thereof; and
a locking member pivotally connected to the supporting member;
wherein the engaging portion of the holding member engages with the locking member, whereby the supporting member, the holding member and the locking member cooperatively define a triangular structure for supporting the portable electronic device at an angle.

2. The support as claimed in claim 1, wherein the supporting member comprises a first plate and a pair of first arms extending upwardly from two opposite lateral sides of the first plate.

3. The support as claimed in claim 2, wherein the holding member comprises a second plate supporting the portable electronic device, and a pair of second arms extending upwardly from two opposite lateral sides of the second plate for holding the portable electronic device, the engaging portion comprises a tab protruding outwardly from a free end of the second plate.

4. The support as claimed in claim 3, wherein the second arms of the holding member are pivotally connected to the first arms of the supporting member.

5. The support as claimed in claim 3, wherein the locking member comprises a third plate and a pair of third arms extending downward from two opposite lateral sides of the third plate, with at least one elongated slot defined in the third plate.

6. The support as claimed in claim 5, wherein the third arms of the locking member are pivotally connected to the first arms of the supporting member.

7. The support as claimed in claim 5, wherein the tab is received in the at least one elongated slot.

8. The support as claimed in claim 5, wherein the at least one elongated slot comprises a plurality of elongated slots defined in the third plate, the slots parallel to and spaced from each other and arranged in a line, and the tab selectively received in one of the slots.

9. The support as claimed in claim 5, wherein the locking member defines an opening at a lateral side thereof through which the tab of the holding member is able to extend.

10. The support as claimed in claim 9, wherein the tab defines a through hole therein.

11. The support as claimed in claim 5, wherein the holding member is operable to be disposed on the supporting member, and sandwiched between the two first arms of the supporting member.

12. The support as claimed in claim 5, wherein the locking member is operable to be disposed on the holding member, and the holding member and the supporting member are sandwiched between the two third arms of the locking member.

13. The support as claimed in claim 3, wherein the holding member further comprises two contact plates extending horizontally from top portions of the two second arms, respectively, impelling the portable electronic device toward the second plate.

14. The support as claimed in claim 1, wherein the holding member is operable to be received in the supporting member, and the supporting member received in the locking member.

15. A support for supporting a portable electronic device, comprising:
a supporting member;
a holding member comprising one end pivotally connected to the supporting member for holding the portable electronic device thereon, the holding member comprising another end forming a positioning configuration; and
a locking member comprising one end pivotally connected to the supporting member and forming a locking configuration;
wherein, in a first state, the locking configuration of the locking member locks the positioning configuration of the holding member and the supporting member, the holding member and the locking member cooperatively define a triangular structure; and in a second state, the locking configuration of the locking member detaches from the positioning configuration of the holding member, wherein the holding member and the locking member overlap.

16. The support of claim 15, wherein the positioning configuration of the holding member comprises a tab formed at another end of the holding member, the locking configuration of the locking member comprises a plurality of spaced slots defined in a body of the locking member, and whereby the tab can extend through any of the slots.
